(19) United States
(12) Patent Application Publication
(10) Pub. No.: US 2023/0080231 A1
(43) Pub. Date: Mar. 16, 2023

(54) COMPRESSION APPARATUS AND FILLING STATION COMPRISING SUCH AN APPARATUS

(71) Applicant: L'Air Liquide, Societe Anonyme pour l'Etude et l?Exploitation des Procedes Georges Claude, Paris (FR)

(72) Inventors: Cyril BENISTAND-HECTOR, Sassenage (FR); Guillaume PETITPAS, Sassenage (FR)

(73) Assignee: L'Air Liquide, Societe Anonyme pour l'Etude et l?Exploitation des Procedes Georges Claude, Paris (FR)

(21) Appl. No.: 17/800,992

(22) PCT Filed: Oct. 21, 2020
(86) PCT No.: PCT/EP2020/079583

§ 371 Date: Aug. 19, 2022

(30) Foreign Application Priority Data
Feb. 21, 2020 (FR) FR 2001725

(51) Int. Cl. F17C 7/02

(52) U.S. Cl. CPC F17C 7/02; F17C 2227/0164; F17C 2221/012; F17C 2265/065; F17C 2270/0178; F17C 2227/0353

(57) ABSTRACT

The invention relates to a fluid compression apparatus comprising a housing having a compression chamber, an intake system communicating with the compression chamber which is configured to allow fluid to be compressed into said compression chamber, and a mobile piston for ensuring the compression of the fluid in the compression chamber. The apparatus further comprises a discharge port which is configured to allow the exit of compressed fluid from the compression chamber, the compression chamber being defined by a portion of the body of the piston and a fixed wall of the apparatus, the piston being translationally mobile along a longitudinal direction. The invention is characterized in that the piston has a tubular portion mounted around a fixed central guide, a first terminal end of the central guide forming the fixed wall delimiting a part of the compression chamber. The apparatus also comprises a sealing system formed between the central guide and the piston according to the longitudinal direction of translation of the piston, the intake system being located at a first end of the apparatus, the discharge port being located at a second end of the apparatus.

### CROSS-REFERENCE TO RELATED APPLICATIONS

This application is a § 371 of International PCT Application PCT/EP2020/079583, filed Oct. 21, 2020, which claims § 119(a) foreign priority to French patent application FR 2001725, filed Feb. 21, 2020.

### BACKGROUND

### Field of the Invention

The invention relates to a cryogenic fluid compression apparatus, and to a filling station comprising such an apparatus.

The invention relates more particularly to a fluid compression apparatus with a compression stage, comprising a casing housing a compression chamber, an intake system that communicates with the compression chamber and is configured to allow the admission of fluid to be compressed into said compression chamber, a mobile piston for ensuring the compression of the fluid in the compression chamber, the apparatus also comprising a discharge orifice configured to allow the compressed fluid to leave the compression chamber, the compression chamber being delimited by a portion of the body of the piston and a fixed wall of the apparatus, the piston being mobile in a translational movement in a longitudinal direction.

The invention relates in particular to an apparatus for compressing or pumping cryogenic gases and/or liquids.

### Related Art

In the following text, in particular the terms “compression apparatus” and “pump” may be used interchangeably, as may the terms “pumping” and “compression”. Specifically, the apparatus that is the subject of the invention is an apparatus for pumping and/or compressing liquid and/or gaseous and/or supercritical cryogenic fluid.

Cryogenic fluids have densities that are much higher than gaseous fluids. Consequently, cryogenic pumps (as opposed to gas compressors) offer higher mass flow rates, a smaller volume, consume less energy and require less maintenance. It is for this reason that cryogenic pumps are used in numerous fields such as units for separating gases from air, reformers, filling stations, maritime sectors.

The fluids in question generally comprise oxygen, nitrogen, natural gas, argon, helium or hydrogen. These compression apparatuses (or pumps) have the function of pressurizing a cryogenic fluid to a target flow rate.

For example, a cryogenic piston pump may be placed directly in line at the outlet of the cryogenic source store or in a dedicated cryogenic bath (also known as a “sump”) situated alongside and fed directly by a main storage tank.

For various reasons, in particular the convenience of maintenance and design, the cryogenic pump generally exhibits a reciprocating movement and is inserted into a tank so as to be submerged in the cryogenic fluid to be pumped.

Cryogenic pumps generally have inlet pressures of between 1 and 12 bar and outlet pressures of 200 to 1000 bar, depending on the application. The pumps may have one or more compression stages using a back-and-forth movement.

The key performance indicators for cryogenic piston pumps are: the volumetric efficiency, the evaporation losses, the energy consumption, the footprint and the durability.

The key features of reciprocating cryogenic pumps should therefore be:
an intake density that is high as possible,
very good thermal insulation with respect to the environment,
a minimum dead volume (which is to say a high compression ratio), a simple and robust setup for rapid maintenance and high reliability,
good control of evaporation losses in order to limit the impact thereof.

U.S. Pat. No. 7,410,348 describes a horizontal piston pump with two compression stages and axial intake via a nonreturn valve and radial discharge. This setup exhibits a relatively substantial dead volume. In addition, the leakage losses are relatively high at two systems of high-pressure seals situated one on either side of the high-pressure chamber.

This also leads to a more difficult setup and more difficult maintenance.

### SUMMARY OF THE INVENTION

One aim of the present invention is to overcome all or some of the abovementioned disadvantages of the prior art.

To this end, the compression apparatus according to the invention, in other respects in accordance with the generic definition thereof given in the above preamble, is essentially characterized in that the piston comprises a tubular portion mounted around a fixed central guide, a terminal first end of the central guide forming the fixed wall delimiting part of the compression chamber, the apparatus comprising a sealing system formed between the central guide and the piston, and, in the longitudinal direction of translation of the piston, the intake system is situated at a first end of the apparatus, the discharge orifice being situated at a second end of the apparatus.

Furthermore, embodiments of the invention can comprise one or more of the following features:
the entirety of the compression chamber is contained in the tubular portion of the piston,
when the compression apparatus is in an operating configuration, the longitudinal direction of translation of the piston is vertical, the intake system being situated at a lower end of the apparatus, the discharge orifice being situated at an upper end of the apparatus,
when the compression apparatus is in an operating configuration, the longitudinal direction of translation of the piston is vertical, the intake system being situated at a lower end of the apparatus, the discharge orifice being situated at an upper end of the apparatus,
in the longitudinal direction, a first end of the compression chamber is delimited by a first end of the tubular piston, and a second end of the compression chamber is delimited by the terminal first end of the central guide and the sealing system formed between the central guide and the piston, said sealing system being situated level with or adjacent to the terminal first end of the central guide,
the sealing system formed between the central guide and the piston is situated only at the level of the second end of the compression chamber and/or beyond this second end in the direction of the second end of the apparatus in the longitudinal direction,
the discharge orifice is situated at the level of the terminal first end of the central guide, the apparatus comprising a duct for discharging the compressed gas and comprising a first end connected to the discharge orifice and a second end situated at the second end of the apparatus,
the intake system is situated at a first end of the piston,
the intake system comprises at least one of the following: one or more nonreturn valves, one or more orifices or ports, at least one flat-disc valve or valves configured to allow the admission of fluid that is to be compressed into the compression chamber during an intake phase and to prevent fluid from leaving in the compression phase,
the compression of the fluid in the compression chamber is brought about by a stroke of the piston in the direction of the second end of the apparatus,
the apparatus is housed in a sealed enclosure containing a bath of cryogenic cooling fluid.

The invention also relates to a station for filling tanks of pressurized gas comprising a source of liquefied gas, in particular liquefied hydrogen, a withdrawal circuit having a first end connected to the source and at least one second end intended to be connected to a tank that is to be filled, the withdrawal circuit comprising a fluid pumping apparatus or a fluid compression apparatus according to any one of the features above or below.

The invention may also relate to any alternative apparatus or method comprising any combination of the features above or below within the scope of the claims.

### BRIEF DESCRIPTION OF THE FIGURES

Other specific features and advantages will become apparent from reading the following description, which is given with reference to the figures, in which:

FIG. 1 shows a schematic and partial view in longitudinal and vertical section illustrating the structure of one exemplary embodiment of a compression apparatus according to the invention,

FIG. 2 shows a schematic and partial view illustrating an example of a filling station using such a compression apparatus.

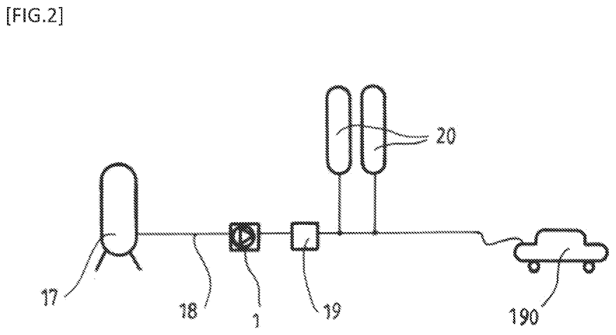

### DETAILED DESCRIPTION OF THE INVENTION

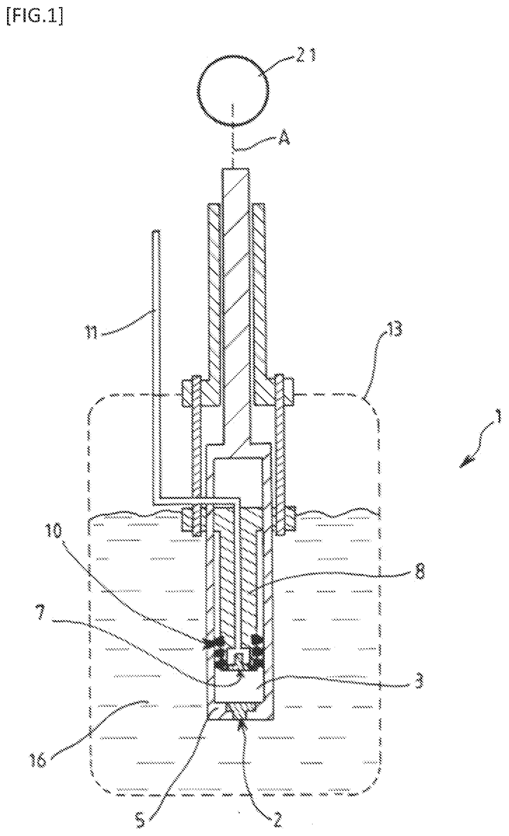

The fluid compression apparatus 1 depicted in [FIG. 1] comprises a single compression stage.

The apparatus 1 particularly comprises a compression chamber 3.

The apparatus 1 comprises an intake system 2 communicating with the compression chamber 3 and which is configured to allow fluid that is to be compressed to be admitted into said compression chamber 3. The intake system 2 may comprise for example at least one of: one or more nonreturn valves, one or more orifices or port(s), at least one flat-disc valve or any other device or valve that allows fluid that is to be compressed to be admitted into the first compression chamber 3 during an intake phase and prevents fluid from leaving in the compression phase. In particular, in one possible embodiment, this intake system 2 may open in the case of a given pressure difference between its two ends. In addition, the chamber may possibly be equipped with a relief valve or some other safety element configured to limit the pressure within the chamber to below a given safety threshold. The apparatus 1 comprises a mobile piston 5 capable of translational movement for compressing the fluid in the compression chamber 3 (as detailed hereinafter).

The apparatus 1 also comprises a discharge orifice 7 that communicates with the compression chamber 3 and is configured to allow fluid compressed in the compression chamber 3 to leave (during or at the end of the phase of compression in this chamber). The discharge orifice 7 may be provided with a nonreturn system, which may be of the same type as that of the intake system 2 (for example closed as long as the pressure difference between the compression chamber 3 and the outside is below a given threshold).

The compression chamber 3 is delimited by a portion of the body of the piston 5 and a fixed wall of the apparatus. The piston 5 is able to move in translation in a longitudinal direction A.

The piston 5 preferably comprises, at a first end, a tubular portion mounted around a fixed central guide 8.

As illustrated, the compression chamber 3 may be formed in a tubular cavity or fixed chamber in the piston 5, which cavity or chamber is closed at this first end. The compression chamber 3 may thus be delimited in its lower part by a closed tubular lower end of the piston 5. The intake system 2 may be situated at a lower end of the piston 5.

The rear end of the piston 5 may be mounted so as to slide with respect to a fixed transverse plate held by longitudinal uprights. The structure of the piston 5 is designed so as, in this case, to allow a part (the rear part) of the piston 5 to slide in said plate (or other support(s)).

For example, the lower portion of the piston 5 is tubular (and forms the compression chamber 3) while the opposite (upper) part of the piston 5 is designed to allow the sliding with respect to the support plate. For example, the upper part of the piston 5 has one or more openings for the passage of the plate or support. The piston 5 can be made in one or more pieces that are joined/secured together.

A terminal first end of the central guide 8 may form the fixed wall delimiting a second end of the compression chamber 3. The rest of the compression chamber 3 is delimited by a sealing system 10 (piston rings or the like) formed between the central guide 8 and the piston 5. It should be noted that this sealing system 10 is situated at or beyond the terminal end of the central guide 8, in the direction of the second end of the device 1.

In other words, the tubular portion of the piston 5 forms an enclosure surrounding the entire compression chamber 3. Thus, the compression chamber 3 may be contained entirely in the tubular portion of the piston 5. Thus, the piston 5 may constitute the casing of the compression chamber 3. This architecture makes it possible to confine the compression chamber 3 in the piston 5, the walls of which may be thermalized (that is to say kept cold) effectively, as described below.

This architecture then makes it possible to provide a single high-pressure dynamic sealing system at just one end of the compression chamber 3. Thus, the sealing system 10 formed between the central guide 8 and the piston 5 can be situated only at the second (preferably upper) end of the compression chamber 3.

As a preference, when the apparatus 1 is in the operating configuration, the longitudinal direction A of translational movement of the piston 5 is vertical, the intake system 2 being situated at a lower end of the apparatus 1. The discharge orifice 7 is itself situated in an upper part of the apparatus 1, namely above the intake system 2.

This configuration ensures that fluid that is to be compressed is admitted into the lower part (first end), which is to say into the coldest region of the apparatus 1. In addition, the delivery and any leaks are located in the upper region (second end) of the apparatus. This configuration encourages minimal or zero mixing between the two, relatively cold and hot, regions.

This arrangement with a compression stroke allows good longitudinal separation between the streams of relatively cold fluid (at the intake, preferably in the lower part) and relatively hot fluid (at the exhaust, preferably in the upper part). In particular, the compression stroke in the compression chamber 3 is preferably an upstroke (the rod of the piston 5 being pulled upward and toward the hot part of the apparatus 1).

In particular, this pulled and preferably upward stroke of the piston 5 during the compression to a high pressure generates a tensile force on the rod of the piston. This is favorable from a mechanical standpoint This is because under this tensile force, the rod is not subjected to buckling (which it would be under compression/thrust). In addition, this tensile compression arrangement does not require the piston rod to be guided regularly along its length. This also allows the cross-sectional area of the piston rod to be reduced (for example by making the rod hollow or reducing the diameter thereof). In addition, it makes it possible to reduce the length of the piston rod according to the acceptable level of thermal losses.

As schematically depicted, the piston 5 may be driven by an actuating member 21 (for example a motor member) situated in the upper part (second end of the apparatus 1), which is to say that the motor 21 or actuator is situated, along the longitudinal axis A and with respect to the compression chamber 3, on the opposite side to the intake orifice 2 and on the same side as the discharge orifice 7 and the discharge duct 11. (As a preference, the actuating member 21 is situated beyond this discharge orifice 7 in the direction of the second end).

As illustrated, the intake orifice 2 and the discharge orifice 7 may be situated at two opposite ends of the compression chamber 3 (in the longitudinal direction A).

As illustrated, in the longitudinal direction A, the discharge orifice 7 may be situated between, on the one hand, the intake orifice 2 (in the lower part in the schematic depiction) and, on the other hand, the discharge duct 11 and/or the actuating member 21 (in the upper part in the schematic depiction).

This configuration allows the fixed central guide 8 to be located at the level of or below a cover that closes the upper end of the enclosure 13 at the second end of the apparatus (upper end for example). For example, the central guide 8 is fixed to the upper part (cover or the like) of the enclosure 13.

The actuating member 21 (motor or the like) is advantageously situated outside the enclosure 13, in the upper part of the compression apparatus.

This also makes it possible to provide a stroke whereby the piston 5 is pulled toward the second end of the apparatus during the compression phase (is pulled toward the upper end in this example).

By contrast, in the prior art mentioned hereinabove, two high-pressure dynamic sealing systems were provided, one on each side of the chamber with reference to the travel of the piston 5.

In comparison with the prior art, this arrangement greatly reduces manufacturing and maintenance constraints and the risk of leaks.

The discharge orifice 7 may be situated at the terminal end of the central guide 8 (the fixed upper end of the compression chamber 3). The apparatus 1 may comprise a compressed gas discharge duct 11 comprising a first end connected to this discharge orifice 7 and a second end situated in the upper part of the apparatus 1 for collecting the compressed high-pressure fluid.

As illustrated in [FIG. 1], the compression apparatus may be housed in a thermally insulated sealed enclosure 13 containing a bath 16 of cryogenic cooling fluid.

In particular, at least the compression chamber 3 may be submerged in a liquid phase. The upper part of the enclosure 16 may have a gas headspace which collects any leaks in the apparatus 1.

Thus, the cold head of the apparatus 1 may be submerged vertically in a cryogenic bath (sometimes referred to as a sump).

The compression chamber 3 could be fixed directly to the bottom of the bath.

The moving part (the piston 5) preferably has a vertical (up and down) movement.

One example of a compression cycle will now be described.

Starting from an uppermost position of the piston 5 (compression chamber 3 empty), the downward movement of the piston 5 will cause the intake system 2 to open and cold fluid at low pressure to enter the compression chamber 3.

After the bottommost position of the piston 5, the latter reascends. As the piston 5 gradually ascends, the fluid that filled the compression chamber 3 finds itself trapped and compressed.

When the pressure in the compression chamber 3 becomes greater than the determined pressure downstream (for example 20 to 1000 bar, depending on the application), the discharge system 7 opens, emptying the high-pressure fluid upward via the discharge duct 11.

The apparatus returns to the starting configuration and can recommence a cycle.

This architecture with a compression stroke and separation of the cold (at the bottom) and hot (at the top) parts allows the compression to work better. The relatively long distance between the intake at the bottom and the discharge at the top promotes this advantage.

This is because fluid is admitted at a level where the fluid is at its coldest and most dense whereas the hotter fluids are offset upward. This minimizes the risks of mixing and of ebullition in the bath 16. The hot fluids (leaks) can be collected directly in the upper part without the need for dedicated pipework.

This preferred embodiment is not however limiting. As an alternative, the longitudinal axis A could be horizontal in the operating configuration or could be inclined in order to reverse the relative vertical positions described above.

The whole can be housed in a casing.

A compression apparatus 1 of this type (or a plurality in series or in parallel) may be used in any cryogenic installation that requires the pumping or compressing of a cryogenic fluid.

For example, a station for filling tanks of pressurized gas (hydrogen for example) may comprise a source 17 of liquefied gas, a withdrawal circuit 18 having a first end connected to the source and at least one second end intended to be connected to a tank 190 to be filled, the withdrawal circuit 18 comprising such a pumping apparatus 1. The fluid pumped may be vaporized in a downstream exchanger 19 and optionally stored in one or more pressurized buffer tanks 20.

While the invention has been described in conjunction with specific embodiments thereof, it is evident that many alternatives, modifications, and variations will be apparent to those skilled in the art in light of the foregoing description. Accordingly it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context dearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the so event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-11. (canceled)

12. A fluid compression apparatus with a compression stage, comprising:
a casing housing:
a compression chamber;
an intake system that communicates with the compression chamber and is configured to allow the admission of fluid to be compressed into said compression chamber;
a mobile piston for ensuring the compression of the fluid in the compression chamber;
an actuating member for driving the piston;
a discharge orifice configured to allow compressed fluid to leave the compression chamber toward a discharge duct; and
a sealing system, wherein:
the compression chamber is delimited by a portion of the body of the piston and a fixed wall of the apparatus,
the piston is mobile in a translational movement in a longitudinal direction,
the piston comprises a tubular portion mounted around a fixed central guide,
a terminal first end of the central guide forms the fixed wall delimiting part of the compression chamber,
the sealing system is formed between the central guide and the piston;
in a longitudinal direction of translation of the piston, the intake system is situated at a first end of the apparatus,
the actuating member is situated at a second end of the apparatus; and,
the discharge orifice is situated between the intake system and the actuating member.

13. The apparatus of claim 12, wherein an entirety of the compression chamber is contained within the tubular portion of the piston.

14. The apparatus of claim 12, wherein:
when the compression apparatus is in an operating configuration, the longitudinal direction of translation of the piston is vertical;
the intake system is situated at a lower end of the apparatus; and
the discharge orifice extends toward an upper end of the apparatus.

15. The apparatus of claim 12, wherein:
in the longitudinal direction, a first end of the compression chamber is delimited by a first end of the tubular piston;
a second end of the compression chamber is delimited by the terminal first end of the central guide and the sealing system formed between the central guide and the piston; and
said sealing system is situated level with or adjacent to the terminal first end of the central guide.

16. The apparatus of claim 12, wherein the sealing system is situated only at a level of the second end of the compression chamber and/or beyond the second end in a direction of the second end of the apparatus in the longitudinal direction.

17. The apparatus of claim 12, wherein:
the discharge orifice is situated at a level of the terminal first end of the central guide; and
the apparatus further comprises a duct for discharging the compressed fluid and which comprises a first end connected to the discharge orifice and a second end situated at the second end of the apparatus.

18. The apparatus of claim 12, wherein the intake system is situated at a first end of the piston.

19. The apparatus of claim 12, wherein the intake system comprises at least one of the following:
one or more nonreturn valves;
one or more orifices or ports; and
at least one flat-disc valve or valves configured to admit fluid that is to be compressed into the compression chamber during an intake phase and prevent fluid from leaving in the compression phase.

20. The apparatus of claim 12, wherein compression of the fluid in the compression chamber is brought about by a stroke of the piston in a direction of the second end of the apparatus.

21. The apparatus of claim 12, wherein the apparatus is housed in a sealed enclosure containing a bath of cryogenic cooling fluid, said enclosure forming part of the compression apparatus.

22. A station for filling tanks with pressurized gas, comprising:
a source of liquefied hydrogen; and
a withdrawal circuit having a first end connected to the source and at least one second end intended to be connected to a tank to be filled, the withdrawal circuit comprising the fluid compression apparatus of claim 12.
